(19) United States
(12) Patent Application Publication
(10) Pub. No.: US 2013/0335348 A1
(43) Pub. Date: Dec. 19, 2013

(54) DUAL DISPLAY DEVICE AND METHOD OF CONTROLLING THE SAME

(71) Applicant: SAMSUNG DISPLAY CO., LTD., Yongin-City (KR)

(72) Inventors: Kee-Hyun Nam, Yongin-City (KR); Yea-Seul Kim, Yongin-City (KR)

(73) Assignee: Samsung Display Co., Ltd., Yongin-City (KR)

(21) Appl. No.: 13/761,072

(22) Filed: Feb. 6, 2013

(30) Foreign Application Priority Data
Jun. 14, 2012 (KR) 10-2012-0063869

(51) Int. Cl. G09G 3/32

(52) U.S. Cl. CPC G09G 3/3208
USPC 345/173; 345/1.3

(57) ABSTRACT

A dual display device includes: a transparent first display device; a second display device coupled to the first display device; and a controller for controlling first information regarding an external environment to be displayed on at least one of the first display device or the second display device.

### CROSS-REFERENCE TO RELATED PATENT APPLICATION

This application claims priority to and the benefit of Korean Patent Application No. 10-2012-0063869, filed on Jun. 14, 2012, in the Korean Intellectual Property Office, the disclosure of which is incorporated herein in its entirety by reference.

### BACKGROUND

1. Field

Embodiments of the present invention relate to a display device and a method of controlling the same, and more particularly, to a dual display device and a method of controlling the same.

2. Description of the Related Art

A conventional portable display device may include a single display, such as an organic light-emitting display device. As organic light-emitting display devices may have a larger viewing angle, better contrast characteristics, a faster response rate, and a lower power consumption than other display technologies, applications thereof have increased in personal portable devices, such as in portable music players (e.g., MP3 players) and mobile phones and in larger devices such as televisions.

Organic light-emitting display devices may be classified into transparent organic light-emitting display devices and opaque organic light-emitting display devices. In this regard, a conventional portable display device having an organic light-emitting display panel includes an opaque organic light-emitting display device.

### SUMMARY

Embodiments of the present invention are directed to a dual display device providing information through virtual augmented reality and a method of controlling the dual display device.

According to one embodiment of the present invention, a dual display device includes a transparent first display device; a second display device coupled to the first display device; and a controller configured to control at least one of the first display device or the second display device to display first information regarding an external environment.

The first display device and the second display device may be coupled to each other in a folding type manner.

The dual display device may further include a position determining unit for sensing a position of the dual display device.

The first information may correspond to a position sensed by the position determining unit.

The first information may include at least one of map information, store information, item information, direction information, or neighborhood information.

The position determining unit may include at least one of a gyroscopic sensor or a global positioning system (GPS) receiver.

The first information may be information uploaded to the dual display device via a communication device or stored in the controller.

At least one of the first display device and the second display device may be a touch screen configured to receive an input signal from a user.

If the input signal is input to at least one of the first display device or the second display device, the controller may be configured to control at least one of the first display device or the second display device to display second information corresponding to the input signal from among the first information.

According to another embodiment of the present invention, a method of controlling a dual display device includes: sensing a position of the dual display device using a position determining unit; and displaying first information corresponding to the sensed position on at least one of a first display device or a second display device, wherein at least one of the first display device or the second display device is transparent.

The first information may include at least one of map information, store information, item information, direction information, or neighborhood information.

The first information may be information uploaded to the dual display device via a communication device or stored in the controller.

The method may further include receiving an input signal via at least one of the first display device or the second display device, wherein at least one of the first display device or the second display device is a touch screen.

If the input signal is input to at least one of the first display device or the second display device, the controller may control at least one of the first display device or the second display device to display second information corresponding to the input signal from among the first information.

The position determining unit may include at least one of a gyroscopic sensor or a global positioning system receiver.

### BRIEF DESCRIPTION OF THE DRAWINGS

The above and other features and aspects of the present invention will become more apparent by describing in detail exemplary embodiments thereof with reference to the attached drawings in which:

FIG. 1 is a perspective view of a dual display device according to an embodiment of the present invention;

FIG. 2 is a cross-sectional view of a first display device in accordance with the embodiment shown in FIG. 1;

FIG. 3 is a schematic view of the first display device in accordance with the embodiment shown in FIG. 1;

FIG. 4 is a block diagram of the dual display device in accordance with the embodiment shown in FIG. 1;

FIG. 5 is a plan view of the first display device in accordance with the embodiment shown in FIG. 1; and

FIG. 6 is a plan view of a second display device in accordance with the embodiment shown in FIG. 1.

### DETAILED DESCRIPTION

Embodiments of the present invention will now be described more fully with reference to the accompanying drawings, in which exemplary embodiments of the invention are shown.

Embodiments of the invention may be embodied in many different forms and should not be construed as being limited to the embodiments set forth herein; rather, these embodiments are provided so that this disclosure will be thorough and complete, and will convey the concept of the invention to one of ordinary skill in the art. It will also be understood that when a layer is referred to as being “on” another layer or substrate, it can be directly on the other layer or substrate, or intervening elements may also be present between the layer and the other layer or substrate. In the drawings, the thicknesses of layers and regions are exaggerated for clarity. Like reference numerals in the drawings denote like elements, and thus their description will be omitted. The words “and/or” used in the present invention includes any and all combinations of one or more of the associated listed items.

Also, though terms like a first and a second are used to describe various elements, components, regions, layers, and/or portions in various embodiments of the present invention, the elements, components, regions, layers, and/or portions should not be limited by these terms. These terms are only used to distinguish one element, component, region, layer, or portion from another. Expressions such as “at least one of,” when preceding a list of elements, modify the entire list of elements and do not modify the individual elements of the list.

A dual display device 100 according to embodiments of the present invention may be formed in various ways. For example, the dual display device 100 may be used in a mobile phone, a laptop computer, a personal digital assistant (PDA), and the like. Hereinafter, for the sake of convenience, embodiments of the present invention in which the dual display device 100 is used in a mobile phone will be mainly described, but embodiments of the present invention are not limited thereto.

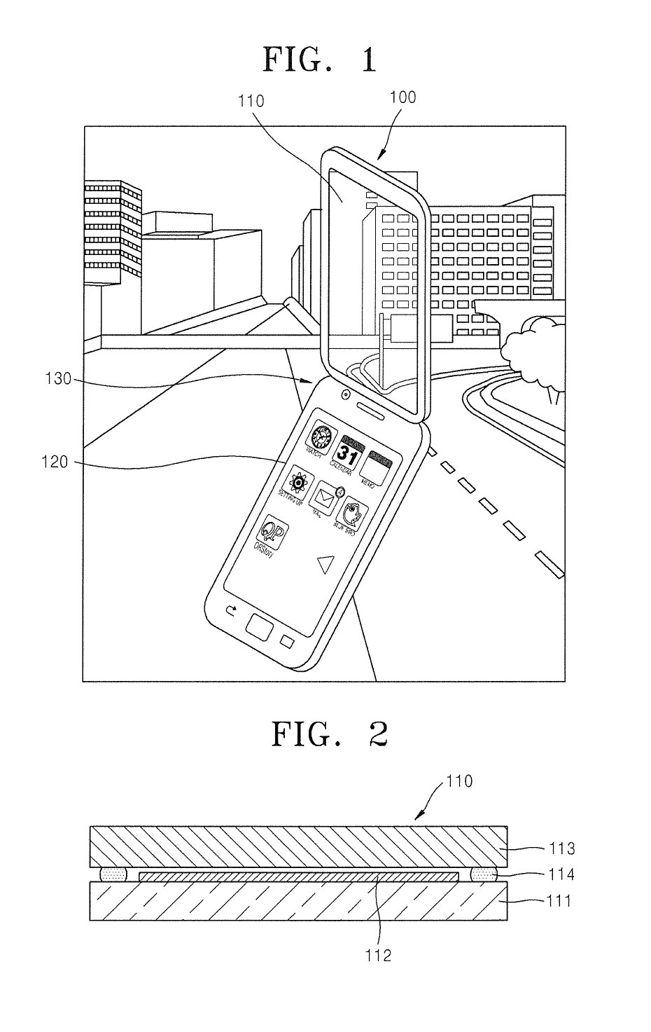

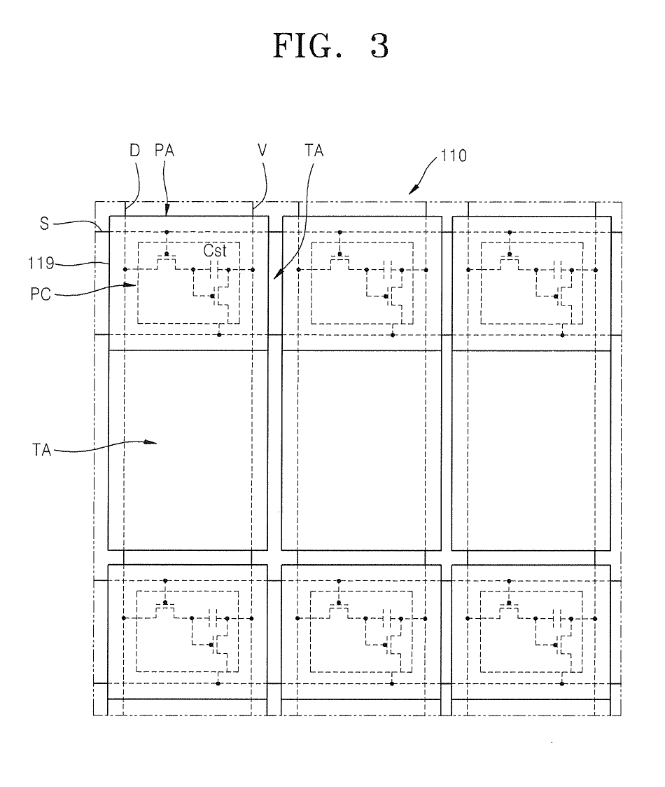

FIG. 1 is a perspective view of the dual display device 100 according to an embodiment of the present invention. FIG. 2 is a cross-sectional view of a first display device 110 shown in FIG. 1. FIG. 3 is a schematic view of the first display device 110 shown in FIG. 1.

Referring to FIGS. 1, 2, and 3, according to one embodiment of the present invention, the dual display device 100 includes the first display device 110 that is formed of a transparent material. The first display device 110 includes a substrate 111, an organic light-emitting unit 112, and a sealing substrate 113 for sealing the organic light-emitting unit 112. The sealing substrate 113 may be formed of a transparent material so that an image displayed by the organic light-emitting unit 112 may pass through the sealing substrate 113, and the sealing substrate 113 may prevent or substantially prevent external air and moisture from penetrating the organic light-emitting unit 112.

Edges of the substrate 111 and the sealing substrate 113 are coupled to each other by using a sealing material 114, and thus, a space between the substrate 111 and the sealing substrate 113 may be sealed. In particular, a moisture absorbent or a filling material may be disposed in the space to prevent (or reduce the likelihood of) the organic light-emitting unit 112 from being damaged due to penetration of external air or moisture.

According to one embodiment, the transparent first display device 110 (or the first display device) includes a plurality of pixel areas PA and a plurality of light transmission areas TA. The pixel areas PA and the light transmission areas TA may be spaced apart from one another at intervals (e.g., predetermined intervals). In particular, each pixel area PA and each light transmission area TA may be alternately formed.

Various structures may be formed in each pixel area PA. For example, a pixel circuit unit PC may be formed in the pixel area PA. Also, a plurality of conductive lines, for example, a scan line S, a data line D, and a Vdd line V may be connected to the pixel circuit unit PC in the pixel area PA. In this regard, any other lines in addition to the scan line S, the data line D, and the Vdd line V, which is a driving power source, may be formed in the pixel area PA according to a structure of the pixel circuit unit PC.

The pixel circuit unit PC may include a first thin film transistor connected to the scan line S and the data line D and a second thin film transistor connected to the first thin film transistor and the Vdd line V. Also, the pixel circuit unit PC may include a capacitor Cst coupled to the first thin film transistor and the second thin film transistor.

The first thin film transistor may serve as a switching transistor, and the second thin film transistor may serve as a driving transistor. In particular, the second thin film transistor may be electrically connected to the first pixel electrode 119.

In some embodiments, the pixel circuit unit PC is not formed in the light transmission area TA. Also, a partial opening may be formed in the light transmission area TA.

As described above, when the pixel area PA and the light transmission area TA are formed in the first display device 110, external light (e.g., light not generated by the first display device 110) may pass through the light transmission area TA. In detail, the pixel circuit unit PC formed in the pixel area PA may be minutely formed (e.g., sufficiently small) so as not to obstruct or significantly obstruct a user's view. In particular, when the pixel area PA is formed in the first display device 110, the pixel circuit unit PC of the pixel area PA may be seen as a minute dot.

Also, because the pixel circuit unit PC is not formed in the light transmission area TA, external light may penetrate (or pass through) the light transmission area TA. In this regard, because a plurality of conductive lines such as the scan line S, the data line D, and the Vdd line V are formed to have a minute structure (e.g., are thin), even though the conductive lines are formed in the light transmission area TA, the conductive lines do not obstruct a user's view (e.g., are substantially invisible to a user).

According to one embodiment, the dual display device 100 includes a second display device 120 connected to the first display device 110. The second display device 120 may be formed in various ways. The second display device 120 may be any of various types of devices such as a liquid crystal display (LCD) and an organic light-emitting display.

Hereinafter, for the sake of convenience, an embodiment in which the second display device 120 includes an organic light-emitting display will be described. However, embodiments of the present invention are not limited thereto. Also, when the second display device 120 is an organic light-emitting display device, the second display device 120 is similar to a general organic light-emitting display device, and thus, a detailed description thereof will be omitted.

As described above, the second display device 120 may be electrically or physically connected to the first display device 110. For example, the second display device 120 may be electrically connected to the first display device 110 to share a driving power source with the first display device 110 or may display an image connected with (e.g., related to) the first display device 110.

In addition, the second display device 120 and the first display device 110 may be physically connected to each other in a folding type manner. For example, the first display device 110 and the second display device 120 may be connected to each other via a separate case 130. In one embodiment, as shown in FIG. 1, the case 130 is foldable, and thus, the first display device 110 and the second display device 120 may be connected to each other in a folding type manner.

At least one of the first display device 110 or the second display device 120 may be a touch screen. The touch screen is formed by using a standard method, and thus, a detailed description thereof will be omitted. Hereinafter, for the sake of convenience, an embodiment in which both the first display device 110 and the second display device 120 are touch screens will be mainly described.

In the dual display device 100, at least one of the first display device 110 or the second display device 120 may include a controller for controlling display of first information regarding an external environment (e.g., the surroundings).

The dual display device 100 may also include a position determining unit for determining a position of the dual display device 100. For example, the position determining unit may sense the present position of the dual display device 100.

The position determining unit may include various devices. For example, the position determining unit may include a global positioning system (GPS) receiver. The position determining unit may also include a gyroscopic (or gyro) sensor. The position determining unit may also include a camera for capturing an external environment. However, embodiments of the present invention are not limited thereto, and the position determining unit may include any device capable of sensing a position of the dual display device 100. Hereinafter, for the sake of convenience, an embodiment in which the position determining unit includes a GPS receiver and a gyroscopic sensor will be described.

Hereinafter, operations of the dual display device 100 will be described in additional detail.

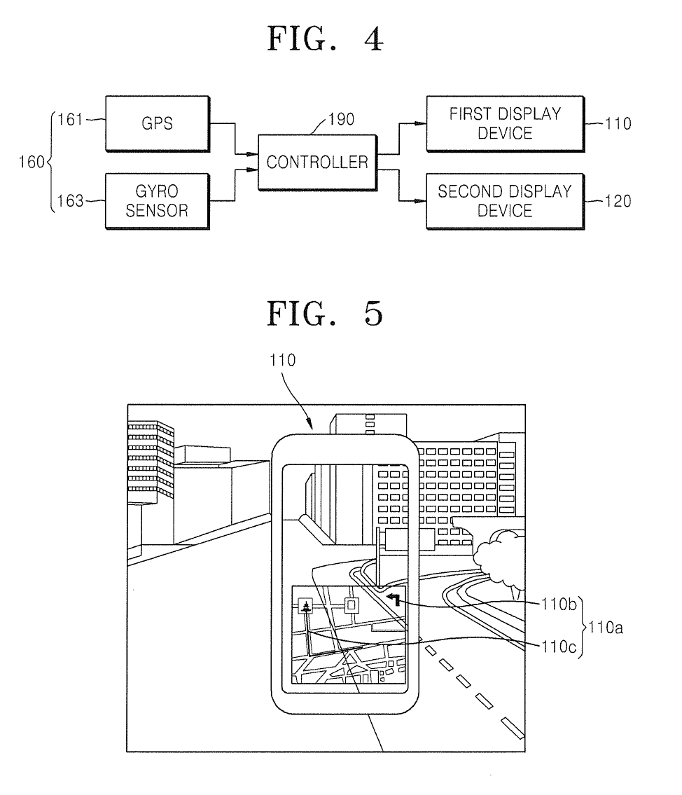

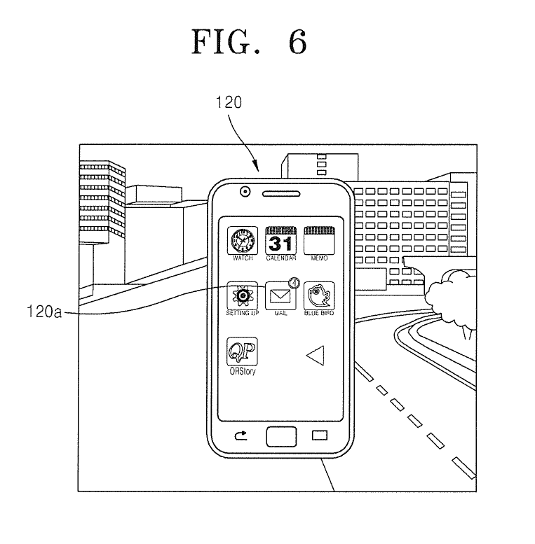

FIG. 4 is a block diagram of the dual display device 100 shown in FIG. 1. FIG. 5 is a plan view of the first display device 110 shown in FIG. 1. FIG. 6 is a plan view of the second display device 120 shown in FIG. 1.

Referring to FIGS. 4, 5, and 6, according to one embodiment, the dual display device 100 is operated through the following processes.

1. Process of Operating at Least One of First Display Device or Second Display Device

The controller 190 may be configured to control at least one of the first display device 110 or the second display device 120. In this regard, any of one or both the first display device 110 and the second display device 120 may be operated. Hereinafter, for the sake of convenience, an embodiment in which both the first display device 110 and the second display device 120 are operated will be mainly described.

As described above, when the first display device 110 and the second display device 120 are operated, the first display device 110 and the second display device 120 may display descriptive information (e.g., information of an arbitrary nature) stored in the controller 190. In detail, the first display device 110 and the second display device 120 may display icons, emoticons, or the like representing general information. Alternatively, the second display device 120 may display the descriptive information, and the first display device 110 may display additional information related to the information displayed on the second display device 120.

2. Process of Sensing Position of Dual Display Device

The controller 190 may sense a position of the dual display device 100. In detail, a GPS receiver 161 may receive position information regarding the dual display device 100 from a satellite. In this regard, the GPS receiver 161 may send the position information to the controller 190. The controller 190 may determine the present position of the dual display device 100 by comparing the position information with a piece of position information (e.g., a predetermined piece of position information).

A gyro sensor 163 may sense an amount of inclination and an amount of rotation (e.g., azimuth) of the dual display device 100. In detail, the gyro sensor 163 may sense the amount of inclination and amount of rotation of the dual display device 100 and send the sensed inclination and rotation data to the controller 190.

The controller 190 may receive an amount of rotation and amount of inclination of the dual display device 100 and calculate an angle of rotation and an angle of inclination of the dual display device 100 based on a set value corresponding to the amounts of rotation and inclination.

3. Process of Displaying First Information by at Least One of First Display Device or Second Display Device

As described above, if the position of the dual display device is determined, the controller 190 may display a first information 120a corresponding to the determined position in at least one of the first display device 110 or the second display device 120. In this regard, the first information 120a may be displayed in any one of or both the first display device 110 and the second display device 120. Hereinafter, for the sake of convenience, an embodiment in which the first information 120a is displayed in the second display device 120 will be mainly described.

The first information 120a may include various pieces of information. For example, the first information 120a may include at least one of map information, store (e.g., retail business) information, item information, direction information (e.g., driving directions), or neighborhood information (e.g., nearby points of interest). However, embodiments of the present invention are not limited thereto, and the first information 120a may include any information related to the position of the dual display device 100.

In more detail, according to one embodiment, the map information shows a map according to the position of the dual display device 100. For example, the position of the dual display device 100 may be displayed on a current (e.g., up-to-date) commercially available map. In another embodiment, a map appropriate for the position of the dual display device 100 may be displayed. In another embodiment, a satellite picture corresponding to the position of the dual display device 100 may be displayed.

The store information may be information regarding a store in front of the dual display device 100. For example, if the store is a restaurant, the store information may include a menu, customers' reviews, price information, etc.

The item information may be information regarding goods sold in the store where the dual display device 100 is located. For example, if the store is a shoe store, the item information may include information regarding prices of all shoes sold in the shoe store. Alternatively, if the store is a cosmetics store, the item information may include information regarding prices of cosmetics sold in the cosmetics store. However, embodiments of the present invention are not limited thereto, and the item information may include various pieces of information regarding items, for example, customers' preferences, information regarding the best-selling item, and information regarding the most commonly searched item.

The direction information may include various pieces of direction information, for example, a way (e.g., route) to a user's destination, an azimuth orientation, directions to neighboring roads, etc. The direction information may be displayed in an outer region of the second display device 120, or may be displayed in another area (e.g., a predetermined area) of the second display device 120.

The neighborhood information may include various pieces of information. For example, the neighborhood information may include information regarding an external environment around the dual display device 100 such as information regarding locations of neighboring buildings, neighboring stores, directions to neighboring roads, locations of neighboring subway stations, etc.

The first information 120a may be uploaded to the dual display device 100 via a communication device (e.g., an external communication device for receiving information from an external source over a network such as the Internet) or may be information previously stored in the controller 190. For example, if the position of the dual display device 100 is determined, the controller 190 may communicate with an external server, and thus the first information 120a may be uploaded to the controller 190 from the external server.

Furthermore, in embodiments in which the first information 120a is stored in the controller 190, the first information 120a may be transmitted to the second display device 120 from the controller 190 based on the position of the dual display device 100 as determined by the position determining unit 160 and may be displayed on the second display device 120. In more detail, the controller 190 may determine the position of the dual display device 100 by comparing the position of the dual display device 100 as determined by the position determining unit 160 with a particular position and then send the first information 120a corresponding to the position of the dual display device 100 to the second display device 120 and may be displayed on the second display device 120.

4. Process of Receiving Input Signal from the Outside

During the operation of the dual display device 100, the dual display device 100 may receive an input signal from the outside. In this regard, the input signal may be input to at least one of the first display device 110 or the second display device 120. In particular, at least one of the first display device 110 or the second display device 120 may be a touch screen, as described above, to directly receive the input signal. However, embodiments of the present invention are not limited thereto, and the input signal may be input to at least one of the first display device 110 or the second display device 120 via a separate input unit.

Hereinafter, for the sake of convenience, an embodiment in which the input signal is input to at least one of the first display device 110 or the second display device 120 will be mainly described.

The input signal may be a signal for selecting second information 110a, to be described below, from among the first information 120a. In more detail, the second information 110a may include information subdivided from the first information 120a, and the input signal may be a signal for selecting the second information 110a from among the first information 120a.

5. Process of Displaying Second Information (a Method of Displaying the Second Information Relates to a Route)

As described above, according to one embodiment of the present invention, if the input signal is input, the second information 110a may be displayed on any one of the first display device 110 and the second display device 120. In more detail, the second information 110a may be displayed on any one of or both the first display device 110 and the second display device 120. Hereinafter, for the sake of convenience, an embodiment in which the second information 110a is displayed on the first display device 110 will be mainly described.

As described above, the second information 110a may vary depending on the first information 120a. Hereinafter, for the sake of convenience, an embodiment in which the first information 120a is map information will be mainly described.

The first information 120a, which, in one embodiment, is map information, may be displayed on the second display device 120. In this regard, the first information 120a may vary depending on the position of the dual display device 100.

In more detail, if the dual display device 100 is at a first position, the first information 120a may be information corresponding to the first position. Also, if the dual display device 100 is at a second position different from the first position, the first information 120a may be information corresponding to the second position.

For example, the first information 120a corresponding to the first position may be a map regarding the first position and areas near (or surrounding) the first position. Also, the second information 110a may be a map regarding the second position and areas near (or surrounding) the second position.

If the first information 120a is displayed on the second display device 120, a user may input an input signal to the second display device 120 through a touch operation. If the input signal is input to the second display device 120, the controller 190 may display the second information 110a corresponding to the input signal from among the first information 120a on the first display device 110.

For example, the first information 120a displayed on the second display device 120 may be a map corresponding to the position of the dual display device 100. In this regard, if a user touches the second display device 120, the position of the dual display device 100 may be displayed on the map. In particular, if the user touches the second display device 120 as described above, a departure point, a destination, etc., may be displayed on the second display device 120 to be selected by the user.

In this regard, the user may input the input signal to select the present position as the starting point and may input the input signal to select another position on the map as the destination.

In this case, a route 110b from the starting point to the destination may be displayed on at least one of the first display device 110 or the second display device 120. Also, a direction 110c toward the destination may be displayed on at least one of the first display device 110 or the second display device 120.

Hereinafter, for the sake of convenience, an embodiment in which the route 110b is displayed on the second display device 120 and the direction 110c is displayed on the first display device 110 will be mainly described.

In more detail, if the starting point and the destination are selected by the user, the route 110b from the starting point to the destination may be displayed on the map of the second display device 120.

In this regard, there may be various methods of displaying the route 110b. For example, the route 110b may be displayed by using an arrow, or the route 110b may be displayed to overlap the map (e.g., as an overlay on the map). Alternatively, the route 100b may be displayed as letters (e.g., letters overlaid on the map).

According to one embodiment of the present invention, if the input signal is input to the second display device 120, a direction toward (e.g., along) the route 110b, which is the second information 110a, may be displayed on the first display device 110. The second information 110a displayed on the first display device 110 may include various pieces of information as well as the direction.

For example, the second information 110a may be information regarding various road signs at the present position of the dual display device 100. Also, the second information 110a may be information regarding stores at the present position of the dual display device 100.

Meanwhile, according to one embodiment of the present invention, the first display device 110 is transparent (e.g., formed of a transparent material) as described above, and thus, an external scene may be displayed through the first display device 110. In this regard, the first display device 110 may display the second information 110a while displaying the external scene.

Also, the second information 110a displayed on the first display device 110 may be changed in real time. For example, if the dual display device 100 is rotated, the gyro sensor 163 may measure the rotation of the dual display device 100 and transmit the measured rotation of the dual display device 100 to the controller 190.

The controller 190 may determine the present position of the dual display device 100 and control the first information 120a and the second information 110a corresponding to the present position of the dual display device 100 to be displayed at least one of the first display device 110 or the second display device 120.

According to the dual display device 100 and the method of controlling the dual display device 100 of the present invention, the second information 110a may be displayed while displaying (e.g., transmitting) external scene (e.g., external light) through the transparent first display device 110, and thus, various pieces of information corresponding to the present position of the dual display device 100 may be effectively transmitted to a user in combination with the external scene (e.g., overlaid on the external scene).

Also, according to the dual display device 100 and the method of controlling the dual display device 100 of the present invention, a user may display his or her desired information on at least one of the first display device 110 or the second display device 120, and thus, user convenience may be improved.

In particular, according to the dual display device 100 and the method of controlling the dual display device 100 of embodiments of the present invention, the first display device 110 and the second display device 120 may be connected to each other in a folding type manner, and thus, the size of the dual display device 100 may be reduced or minimized, thereby improving the portability of the dual display device 100.

According to one embodiment of the present invention, second information can be displayed while displaying external scene through a transparent first display device, and thus, various pieces of information corresponding to the present position of a dual display device can be effectively transmitted to a user.

Also, a user can display his or her desired information on at least one of the first display device or a second display device, and thus, user convenience can be improved.

In addition, the first display device and the second display device can be connected to each other in a folding type manner, and thus the size of the dual display device can be minimized, and portability of the dual display device can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A dual display device comprising:
a transparent first display device;
a second display device coupled to the first display device; and
a controller configured to control at least one of the first display device or the second display device to display first information regarding an external environment.

2. The dual display device of claim 1, wherein the first display device and the second display device are coupled to each other in a folding type manner.

3. The dual display device of claim 1, further comprising a position determining unit for sensing a position of the dual display device.

4. The dual display device of claim 3, wherein the first information corresponds to a position sensed by the position determining unit.

5. The dual display device of claim 4, wherein the first information comprises at least one of map information, store information, item information, direction information, or neighborhood information.

6. The dual display device of claim 3, wherein the position determining unit comprises at least one of a gyroscopic sensor or a global positioning system receiver.

7. The dual display device of claim 1, wherein the first information is information uploaded to the dual display device via a communication device or stored in the controller.

8. The dual display device of claim 1, wherein at least one of the first display device or the second display device is a touch screen configured to receive an input signal from a user.

9. The dual display device of claim 8, wherein, if the input signal is input to at least one of the first display device or the second display device, the controller is configured to control at least one of the first display device or the second display device to display second information corresponding to the input signal from among the first information.

10. A method of controlling a dual display device, the method comprising:
sensing a position of the dual display device using a position determining unit; and
displaying first information corresponding to the sensed position on at least one of a first display device or a second display device,
wherein at least one of the first display device or the second display device is transparent.

11. The method of claim 10, wherein the first information comprises at least one of map information, store information, item information, direction information, or neighborhood information.

12. The method of claim 10, wherein the first information is information uploaded to the dual display device via a communication device or stored in the controller.

13. The method of claim 10, further comprising receiving an input signal via at least one of the first display device or the second display device, wherein at least one of the first display device or the second display device is a touch screen.

14. The method of claim 13, wherein, if the input signal is input to at least one of the first display device or the second display device, the controller controls at least one of the first display device or the second display device to display second information corresponding to the input signal from among the first information.

15. The method of claim 10, wherein the position determining unit comprises at least one of a gyroscopic sensor or a global positioning system receiver.
